(19) United States
(12) Patent Application Publication
(10) Pub. No.: US 2013/0118354 A1
(43) Pub. Date: May 16, 2013

(54) PLUME RECOVERY METHOD

(71) Applicant: David M. Polizzotti, Yardley, PA (US)

(72) Inventor: David M. Polizzotti, Yardley, PA (US)

(73) Assignee: General Electric Company, Schenectady, NY (US)

(21) Appl. No.: 13/295,464

(22) Filed: Nov. 14, 2011

(51) Int. Cl. B01D 53/26

(52) U.S. Cl. 95/289

(57) ABSTRACT

Methods for recovering water from the plume of a heat removal or exhaust device are provided. The methods utilize a condensation apparatus (1) with a heat transfer wall (7), a condensation side (3), and a cool-air side (5). The plume is fed to the condensation side (3) as cool air is fed to the cool-air side (5). As the plume travels through the condensation side, water condenses on the heat transfer wall (7).

### FIELD OF INVENTION

The invention pertains to reclaiming water from the effluent of heat removal devices and exhausts, such as smoke stacks, chimneys, flues, and especially cooling towers. The reclaimed water not only reduces water vapor plumes and minimizes water consumption, but is free from typical industrial residual contaminants such as oils and salts.

### BACKGROUND OF THE INVENTION

Cooling towers are widely used in industries to remove excess heat in processes, such as oil refining, chemical processing, and power generating plants. Cooling towers are also used in the HVAC systems common in commercial, institutional, and hospital buildings. One downside to cooling towers, however, is that plumes of water vapor can be created under certain atmospheric conditions. In areas proximate to cooling towers, this water vapor can cause low lying fog and, in freezing temperatures, icing on roads and other structures. In addition, water consumption in cooling tower operation constitutes the largest water withdrawal from natural water sources in many countries. The Department of Energy stated in its report on the Power-Plant R&D Program that power plants consume from 190 to 990 gallons of water per megawatt hour of electricity produced. According to the same report, if all power and industrial towers in the US recovered 20% of the water vapor, it would result in cooling water savings of 1.56 billion gallons per day. Water scarcity has become an increasing concern worldwide. According to the data published by Global environment outlook, 5% of population was facing water scarcity problems in 2000, mainly in the Middle East. However, by year 2030, nearly half of world population will be water stressed.

In addition to the limited water resources, environmental regulation on industrial wastewater disposal is becoming increasingly restricted. Cost of treating wastewater before discharge to the environment is continually increasing.

Water shortage worldwide and stringent environment regulations have led to increasing water conservation effort in all industries. Inevitably, it has significant impact on industry water use, especially on huge water consumption industries. Cooling water system conservation efforts have focused on replacing fresh water with treated municipal effluent, reusing plant wastewater, and reducing water discharge by operating at higher cycles of concentration, such as greater than about 7 cycles.

Another problem with water evaporation is that it results in increased levels of contaminants in the cooling tower reservoir. As water evaporates, it leaves contaminants, including salt behind. As a result, water in the cooling tower reservoir can become highly concentrated with solid contaminants that can cause fouling on cooling tower components. Cooling water supplied from wells can have significant levels of dissolved solids, causing fouling. In areas where salt water is used, increased salt concentrations can also cause fouling. To reduce contaminant concentration, a portion of the reservoir water is removed (“blow-down”) and it is replaced with fresh water.

To reduce cooling water loss through evaporation, methods have been developed for recovering cooling tower plumes. U.S. Pat. No. 7,328,886 (Mockry et al.) discloses a method for recovering plume water within the cooling tower through the use of air-to-air heat exchangers inside the cooling tower. One disadvantage to this method is the presence of the heat exchangers inside the cooling tower decreases air flow through the tower, resulting in decreased tower efficiency.

Thus, there is a strong need for methods of reclaiming water from cooling tower plumes to replace water lost from the cooling tower reservoir without loss in cooling tower efficiency. The reclaimed water not only reduces water vapor plumes and minimizes water consumption, but is free from typical industrial residual contaminants such as oils and salts.

### SUMMARY OF THE INVENTION

In one aspect of the invention, a method for recovering water from the plume of a heat removal or exhaust device is provided. Heat removal and exhaust devices include, but are not limited to cooling towers, flues, smoke stacks, or chimneys. The method utilizes a condensation apparatus to condense the water present in the plume. The apparatus contains a heat transfer wall with a condensation side and a cool-air side. The plume is directed into the condensation side and cool air is supplied to the cool-air side of the apparatus. The water vapor in the plume condenses on the heat transfer wall, forming a liquid condensate. The condensate flows out of the apparatus and may be collected for further use or direct release into the environment.

In another aspect of the invention, the plume or cool air is directed along the apparatus through the use of a natural or mechanical driving force. Mechanical forces include, but are not limited to, fans, turbines, pumps, or vacuums

In yet another aspect of the invention, the flow of the plume on the condensation side of the heat transfer wall is countercurrent to the flow of the cool air on the cool-air side of the heat transfer wall.

In yet another aspect of the invention, the condensation side of the heat transfer wall is covered with a thin coating of nanomaterials. Suitable nanomaterials include, but are not limited to plastics, corrosion-resistant metals, ceramics, carbon fibers, fiber glass or composites.

The present invention and its advantages over the prior art will become apparent upon reading the following detailed description and the appended claims with reference to the accompanying drawings. As will be realized the invention is capable of other and different embodiments, and its details are capable of modification in various respects.

### BRIEF DESCRIPTION OF THE DRAWINGS

FIG. 1 is a cross-sectional view of the condensation apparatus.

### DETAILED DESCRIPTION OF EXEMPLARY EMBODIMENTS

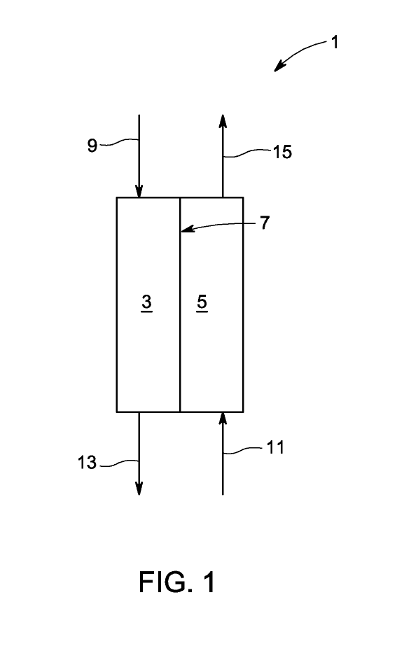

Exemplary embodiments include methods for recovering plumes from heat removal devices and exhausts such as cooling towers, flues, smoke stacks, and chimneys. As depicted in FIG. 1, the methods utilize an apparatus (1) that has a cool-air side (5) and a condensation side (3) separated by a heat transfer wall (7) capable of conducting heat between the two sides. Devices of this type are described in U.S. Pat. No. 6,911,121 B1 (Beckman). The entire content of the '121 patent is hereby incorporated by reference.

The apparatus (1) can be made of any material, preferably a material that is impermeable and will not react with the gas and liquids being processed. Such materials include plastics, corrosion-resistant metals, ceramics, and composites like carbon fibers, and fiber glass. The heat transfer wall (7) is preferably made of a wettable material so the liquid feed forms a thin layer as it flows down the heat transfer wall (7). The heat transfer wall (7) can be coated with a thin, wetting material such as gauze or cheesecloth. Both the condensation side (3) and the cool-air side (5) may have spacers to help direct the liquid and gas flows while reinforcing the heat transfer wall (7).

In one embodiment, the apparatus (1) is located outside a cooling tower. Cooling tower effluent (9), or plume (9), is directed downward through the condensation side (3) of the apparatus (1). The plume (9) may be directed through the use of a natural driving force, such as gravity, or through the use of a mechanical driving force such as a fan, turbine, pump, vacuum, or any other means apparent to those skilled in the fluid transfer art. The cool-air side (5) is fed with cool air (11). As the plume (9) travels down the condensation side (3), heat is transferred from the condensation side (3) to the cool-air side (5) through the heat transfer wall (7). This heat transfer causes the liquid from the plume (9) to condense on the heat transfer wall (7). The condensate (13) then exits at the bottom of the condensation side (3) and is collected. The collected condensate (13) is free from salt and other impurities and can be can be put to other uses throughout the plant, such as cooling tower make up. The remaining plume with reduced moisture content (15) exits out the top of the condensation side (3) and may be released to the environment.

Another embodiment of the invention is used to recover water from the effluent of exhausts, such as chimneys or flues.

In yet another embodiment of the invention, the condensation side (3) of the heat transfer wall (7) is covered with a thin coating of nanomaterials to improve heat transfer and direct condensate (13) flow. These nanomaterials may be made of any material that is capable to being reduced, or constructed, on a nanoscale. Preferably the material is impermeable and will not react with the gas and liquids being processed. Such materials include, but are not limited to, plastics, corrosion-resistant metals, ceramics, and composites like carbon fibers, and fiber glass.

While this invention has been described in conjunction with the specific embodiments described above, it is evident that many alternatives, combinations, modifications and variations are apparent to those skilled in the art. Accordingly, the preferred embodiments of this invention, as set forth above are intended to be illustrative only, and not in a limiting sense. Various changes can be made without departing from the spirit and scope of this invention. Therefore, the technical scope of the present invention encompasses not only those embodiments described above, but also all that fall within the scope of the appended claims.

This written description uses examples to disclose the invention, including the best mode, and also to enable any person skilled in the art to practice the invention, including making and using any devices or systems and performing any incorporated processes. The patentable scope of the invention is defined by the claims, and may include other examples that occur to those skilled in the art. These other examples are intended to be within the scope of the claims if they have structural elements that do not differ from the literal language of the claims, or if they include equivalent structural elements with insubstantial differences from the literal language of the claims.

What is claimed is:

1. A method for recovering water from a plume of a heat removal device comprising:
supplying a condensation apparatus with a heat transfer wall, a condensation side, and a cool-air side;
directing said plume along said condensation side;
directing cool air along said cool-air side; and
condensing water present in said plume on said heat transfer wall of said condensation side.

2. The method of claim 1, wherein said plume or said cool air is directed along said apparatus through use of a natural or mechanical driving force.

3. The method of claim 2, wherein said mechanical force comprises a fan, turbine, pump, or vacuum.

4. The method of claim 1, wherein said plume on said condensation side flows countercurrent to said cool air on said cool-air side of said heat transfer wall.

5. The method of claim 1, wherein said condensation side of said heat transfer wall is covered with a thin coating of nanomaterials.

6. The method of claim 5, wherein said nanomaterials include plastics, corrosion-resistant metals, ceramics, carbon fibers, fiber glass or composites.

7. The method of claim 1, wherein said heat removal device includes a cooling tower.

8. The method of claim 1, wherein recovered water from said plume is collected.

9. A method for recovering water from a plume of an exhaust device comprising:
supplying a condensation apparatus with a heat transfer wall, a condensation side, and a cool-air side;
directing said plume along said condensation side;
directing cool air along said cool-air side; and
condensing water present in said plume on said heat transfer wall of said condensation side.

10. The method of claim 9, wherein said plume or said cool air is directed along said apparatus through use of a natural or mechanical driving force.

11. The method of claim 10, wherein said mechanical force comprises a fan, turbine, pump, or vacuum.

12. The method of claim 9, wherein said plume on said condensation side flows countercurrent to said cool air on said cool-air side of said heat transfer wall.

13. The method of claim 9, wherein said condensation side of said heat transfer wall is covered with a thin coating of nanomaterials.

14. The method of claim 13, wherein said nanomaterials include plastics, corrosion-resistant metals, ceramics, carbon fibers, fiber glass or composites.

15. The method of claim 9, wherein said exhaust device includes a flu, smoke stack, or chimney.

16. The method of claim 9, wherein recovered water from said plume is collected.
